(19) United States
(12) Patent Application Publication
(10) Pub. No.: US 2004/0244776 A1
(43) Pub. Date: Dec. 9, 2004

(54) Cylinder injecting fuel injection valve device

(75) Inventor: Masayuki Aota, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/784,824

(22) Filed: Feb. 24, 2004

(30) Foreign Application Priority Data
Jun. 5, 2003 (JP) 2003-160409

(51) Int. Cl. F02M 61/14

(52) U.S. Cl. 123/470

(57) ABSTRACT

A cylinder injecting fuel injection valve device of the present invention includes: a fuel injection valve including an axially constrained portion formed in an outer periphery of a metal portion so as to protrude radially outwards and a radially constrained portion of a predetermined configuration formed on an outer peripheral surface of a resin portion, and being adapted to inject fuel directly into a cylinder from the fuel injection port; and a retainer one end of which is fixed to the cylinder head and the other end of which has a constraining portion by means of which the fuel injection valve is secured in position, in which the constraining portion of the retainer abuts the axially constrained portion to axially pressurize the fuel injection valve, and is engaged with the radially constrained portion to thereby restrict rotation of the fuel injection valve around an axis.

### BACKGROUND OF THE INVENTION

1. Field of the Invention

The present invention relates to a cylinder injecting fuel injection valve device consisting of a fuel injection valve of a cylinder injection type internal combustion engine and a mounting structure thereof, and more particularly to a fuel injection valve device improved in terms of detent function for the fuel injection valve.

2. Description of the Related Art

In a cylinder injection type internal combustion engine, a fuel injection valve injects fuel directly into a cylinder formed inside the internal combustion engine. This fuel injection valve is mounted to a fuel injection valve insertion hole formed in a cylinder head. The fuel injection valve insertion hole communicates with a cylinder formed inside of a cylinder block. A combustion gas which is injected in the cylinder is sealed by a seal member, such as a corrugated washer, arranged between the cylinder head and the fuel injection valve. The pressure of the combustion gas in the cylinder exerts a force to push the fuel injection valve out of the fuel injection valve insertion hole. Thus, to fix the fuel injection valve to the cylinder head, a great pressurizing force acting in the axial direction of the fuel injection valve is required.

In view of this, there has been proposed a method according to which a flange is provided in the outer periphery of the fuel injection valve, the flange being axially pressurized by a retainer to thereby fix the fuel injection valve to the cylinder head. Conventionally, this flange has been formed on the metal portion of the fuel injection valve so that it may withstand the great pressurizing force.

Further, it is also important that around-the-axis rotation of the fuel injection valve in the cylinder head be restricted. This is because, in a cylinder injecting fuel injection valve, the shape of the fuel spray is often inclined or asymmetrical with respect to the axis of the fuel injection valve due to the layout restrictions, etc. in mounting the fuel injection valve in the cylinder. In such a case, for the fuel to be injected in the proper direction, it is crucial that the fuel injection valve be retained at a predetermined position around the axis.

As a method of performing such positioning in the rotating direction on the fuel injection valve, there has been proposed a method according to which the above-mentioned flange is partially cut away to form on the flange a flat surface perpendicular to a plane including the central line of the injection valve, the flat surface being engaged with the retainer to thereby realize positioning in the rotating direction (See, for example, Japanese Patent Laid-Open Nos. 2000-120508).

Further, there has also been proposed a method according to which a fuel supply duct provided in the periphery of the fuel injection valve is engaged with the fuel injection valve to thereby realize positioning in the rotating direction (See, for example, Japanese Patent Laid-Open Nos. 9-100758).

Furthermore, there has also been proposed a method according to which such positioning in the rotating direction is realized by utilizing the pin of an external plug connector provided in the outer periphery of the fuel injection valve so as to protrude in the axial direction (See, for example, Japanese Patent Nos. 2953225).

In the method according to Japanese Patent Laid-Open Nos. 2000-120508, it is necessary to perform cutting to form a flat surface on the metal flange of the fuel injection valve, resulting in an increase in machining cost.

In the method according to Japanese Patent Laid-Open Nos. 9-100758, it is necessary to newly provide a member for positioning in the rotating direction between the fuel injection valve and the fuel supply duct, which leads to an increase in the number of parts, resulting in an increase in production cost. Further, in this method, according to which the positioning in the rotating direction is effected between the fuel injection valve and the fuel supply duct, a rotating-direction error between the fuel supply duct and the cylinder head is added to the rotating-direction error between the fuel injection valve and the fuel supply duct, resulting in rather poor accuracy in positioning in the rotating direction.

In the method according to Japanese Patent Nos. 2953225, the pin is thin and small, so that elastic deformation of the pin is added to the play in the pin fit-engagement portion, resulting in rather poor accuracy in positioning in the rotating direction.

Further, in a cylinder injecting fuel injection valve, in which fuel is directly injected into the cylinder in spraying fuel, high accuracy in the spray configuration and injecting direction is required.

### SUMMARY OF THE INVENTION

The present invention has been made with a view toward solving the above problems in the prior art. It is an object of the present invention to provide a fuel injection valve device consisting of the fuel injection valve of a cylinder injection type internal combustion engine and a mounting structure thereof, in which it is possible to easily form a rotational positioning structure for the fuel injection valve without involving any increase in cost and it is possible to effect positioning in the rotating direction with high accuracy.

According to the present invention, there is provided a cylinder injecting fuel injection valve device to be mounted to a cylinder head of a cylinder injection type internal combustion engine, including: a fuel injection valve arranged with its forward end side portion with a fuel injection port inserted into a fuel injection valve insertion hole formed in the cylinder head, the fuel injection valve including an axially constrained portion formed in an outer periphery of a metal portion formed on a body portion so as to protrude radially outwards and a radially constrained portion of a predetermined configuration formed on an outer peripheral surface of a resin portion provided on a rear end side with respect to the axially constrained portion, the fuel injection valve being adapted to inject fuel directly into a cylinder from the fuel injection port; and a retainer one end of which is fixed to the cylinder head and the other end of which has a constraining portion by means of which the fuel injection valve is secured in position, in which the constraining portion of the retainer abuts the axially constrained portion to axially pressurize the fuel injection valve toward a cylinder head side, and is engaged with the radially constrained portion to thereby restrict rotation of the fuel injection valve around an axis.

### BRIEF DESCRIPTION OF THE DRAWINGS

In the accompanying drawings:

FIG. 1 is a side view, partly in section, of a cylinder injecting fuel injection valve device according to Embodiment 1 of the present invention;

FIG. 2 is a top view of the cylinder injecting fuel injection valve device of FIG. 1;

FIG. 3 is a sectional view of a fuel injection valve and a cylinder head;

FIG. 4 is a top view of the fuel injection valve of Embodiment 1;

FIG. 5 is a top view of a retainer according to Embodiment 1;

FIG. 6 is a side view, partly in section, of a cylinder injecting fuel injection valve device according to Embodiment 2 of the present invention;

FIG. 7 is a top view of the cylinder injecting fuel injection valve device of FIG. 6;

FIG. 8 is a top view of the fuel injection valve of Embodiment 2;

FIG. 9 is a top view of a retainer according to Embodiment 2;

FIG. 10 is a side view, partly in section, of a cylinder injecting fuel injection valve device according to Embodiment 3 of the present invention; and

FIG. 11 is a top view of the cylinder injecting fuel injection valve device of FIG. 10.

### DESCRIPTION OF THE PREFERRED EMBODIMENTS

Embodiment 1

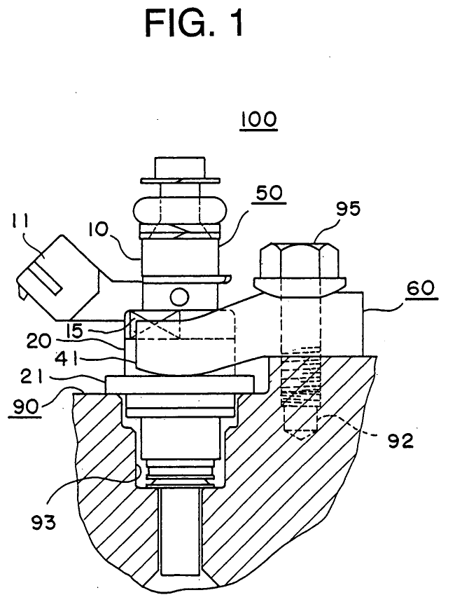

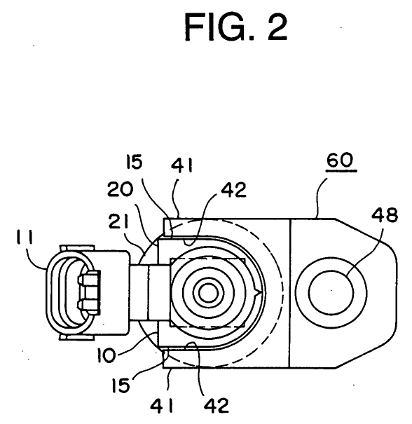

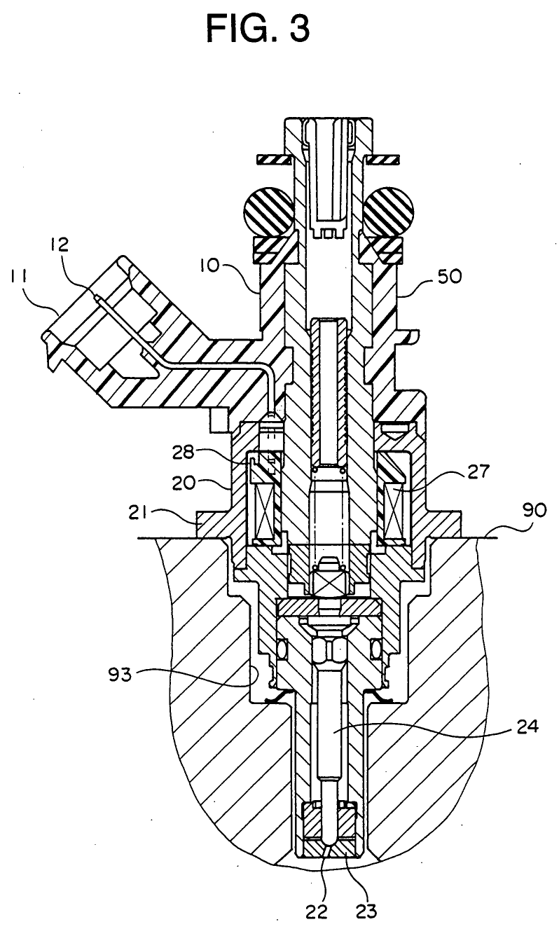

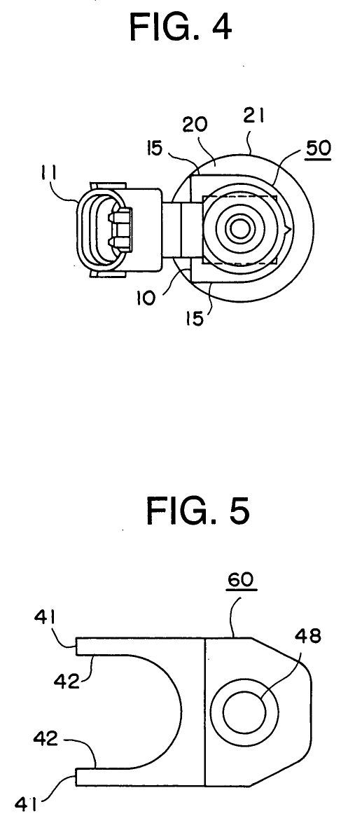

FIG. 1 is a side view, partly in section, of a cylinder injecting fuel injection valve device according to Embodiment 1 of the present invention, and FIG. 2 is a top view of the cylinder injecting fuel injection valve device of FIG. 1. FIG. 3 is a sectional view of a fuel injection valve and a cylinder head. FIG. 4 is a top view of a fuel injection valve, and FIG. 5 is a top view of a retainer.

A cylinder injecting fuel injection valve device 100 is mounted in a fuel injection valve insertion hole 93 formed in a cylinder head 90 of a cylinder injection type internal combustion engine, and has a fuel injection valve 50 adapted to inject fuel directly into a cylinder provided in the internal combustion engine, a retainer 60 for fixing the fuel injection valve 50 to the cylinder head 90, and a bolt 95 for fastening the retainer 60 to the cylinder head 90. The fuel injection valve insertion hole 93 formed in the cylinder head 90 communicates with the cylinder provided in the internal combustion engine.

The fuel injection valve 50 has a metal housing 20 covering the portion thereof from the forward end at which a fuel injection port 22 is provided to substantially the central portion thereof, that is, substantially half the entire fuel injection valve 50, and accommodating the main components of the injection valve, and a resin housing 10 provided in the portion of the fuel injection valve 50 on the opposite side of the cylinder head 90 and integrally molded so as to be connected to the metal housing 20. The metal housing 20 and the resin housing 10 respectively constitute a metal portion and a resin portion of the fuel injection valve 50.

Accommodated in the metal housing 20 are a needle valve 24 which adjusts the amount of fuel injected from the fuel injection port 22 by opening and closing a valve seat 23 provided at the forward end of the fuel injection valve 50, a coil 27 and a solenoid 28 which drives the needle valve 24.

Provided on the resin housing 10 is an external plug connector 11 protruding so as to branch off from the axis of the fuel injection valve 50. Exposed in a recess formed in the external plug connector 11 is a connection terminal 12 extending from the coil 27 and the solenoid 28. The external plug connector 11 is connected to a plug (not shown), and supplies drive power to the coil 27 and the solenoid 28.

Provided substantially at the center of the fuel injection valve 50 is a flange 21 surrounding the entire circumference of the substantially cylindrical body portion of the metal housing 20. The flange 21 constitutes an axially constrained portion of the fuel injection valve 50. The fuel injection valve 50 is inserted into the fuel injection valve insertion hole 93 formed in the cylinder head 90, so as to embed the portion thereof from the forward end to the flange 21, with the flange 21 being axially pressurized by the retainer 60 to thereby secure the fuel injection valve 50 in position. The flange 21 abuts the entire periphery of the opening edge of the fuel injection valve insertion hole 93.

The retainer 60, axially pressurizing the fuel injection valve 50, is formed of an elastic material, and has at one end thereof a through-hole 48 through which the bolt 95 is passed, the bolt 95 being engaged with a bolt hole 92 threaded in the cylinder head 90 for fixation. On the opposite side of the through-hole 48, the retainer 60 has a U-shaped portion 41 with a longitudinal opening. This U-shaped portion 41 axially pressurizes the fuel injection valve 50 toward the cylinder head side, and constitutes a constraining portion regulating around-the-axis rotation of the fuel injection valve 50.

The retainer 60 is engaged with the fuel injection valve 50 so as to hold the resin housing 10 of the fuel injection valve 50 between the claw portions of the U-shaped portion 41, and the side surfaces of the U-shaped portion 41 on the cylinder head 90 side pressurize the flange 21, thereby axially pressing the fuel injection valve 50.

Resin flat surface portions 15 are formed on the portion of the resin housing 10 of the fuel injection valve 50 which is held between the claw portions of the U-shaped portion 41 of the retainer 60. The resin flat surface portions 15 are formed in parallel on the outer peripheral surface of the resin housing 10 so as to be directed in opposite directions. That is, the resin flat surface portions 15 constitute two parallel flat surfaces formed on the outer peripheral surface of the resin housing 10 and parallel to a plane including the central axis of the fuel injection valve 50 and the central axis of the bolt 95. The resin flat surface portions 15 constitute radially constrained portions of the fuel injection valve 50. The opposing two surfaces formed on the inner side of the U-shaped portion 41 are opposed in close proximity to the resin flat surface portions 15, restricting rotation of the fuel injection valve 50 and setting the external plug connector 11 in a predetermined direction.

The external plug connector 11 for supplying drive power for the fuel injection valve 50 is usually formed of resin, so that it is easy to form the resin flat surface portions 15 for rotational positioning integrally with the external plug connector 11 by integral molding.

In the cylinder injecting fuel injection valve device 100 of this embodiment, the resin flat surface portions 15 of the fuel injection valve 50 are formed of resin, whereby it is possible to produce the device at lower cost as compared with the conventional device in which the portion to be engaged with the retainer for rotational positioning is provided on the metal flange. Further, since the flat surface portions 15 are formed of resin, the degree of freedom in design is high, so that it is possible to adopt various engagement forms in conformity with the restriction in shape of the retainer 60.

Further, the resin housing 10 of the fuel injection valve 50 is molded using the flange 21 as the reference, so that it is possible to maintain high dimensional accuracy for the resin flat surface portions 15 with respect to the cylinder head 90 side reference surface (contact surface) of the flange 21. Further, the resin flat surface portions 15 are spaced apart from the central axis of the fuel injection valve 50, so that it is possible to mitigate a deterioration in the rotational position regulation due to the play generated between the U-shaped portion 41 of the retainer 60 and the resin flat surface portions 15.

Further, with respect to each cylinder of the cylinder head 90, the retainer mounting bolt hole 92 and the fuel injection valve insertion hole 93 are arranged in a straight line, so that it is possible to attain high accuracy in the positional relationship between the fuel injection valve 50 and the retainer 60, thereby making it possible to achieve a still higher level of accuracy in the rotational positioning of the fuel injection valve.

As described above, the cylinder injecting fuel injection valve device 100 of this embodiment includes: the fuel injection valve 50 constituting a part of the cylinder injection type internal combustion engine and mounted to the cylinder head 90 provided with the fuel injection valve insertion hole 93 communicating with the cylinder, with its forward side portion with the fuel injection port 22 being inserted into the fuel injection valve insertion hole 93, the fuel injection valve 50 having a flange (axially constricted portion) 21 formed in the outer periphery of the metal housing (metal portion) 20 provided on the body portion so as to protrude radially outwards, and resin flat surface portions (radially constricted portions) 15 of a predetermined configuration formed on the outer peripheral surface of the resin housing (resin portion) 10 provided on the rear end side with respect to the flange 21, the fuel injection valve 50 being adapted to inject fuel directly into the cylinder from the fuel injection port 22; and the retainer 60 one end of which is fixed to the cylinder head 90 and the other end of which has the U-shaped portion (constricting portion) 41 for securing the fuel injection valve 50 in position, wherein the U-shaped portion 41 of the retainer 60 abuts the flange 21 and axially pressurizes the fuel injection valve 50 toward the cylinder head 90 side, and is engaged with the radially constricted portions 15 to thereby restrict around-the-axis rotation of the fuel injection valve 50. Thus, it is possible to easily realize a rotational positioning structure for the fuel injection valve without involving any increase in cost, and to achieve high level of accuracy in the positioning of the fuel injection valve 50 in the rotating direction.

Embodiment 2

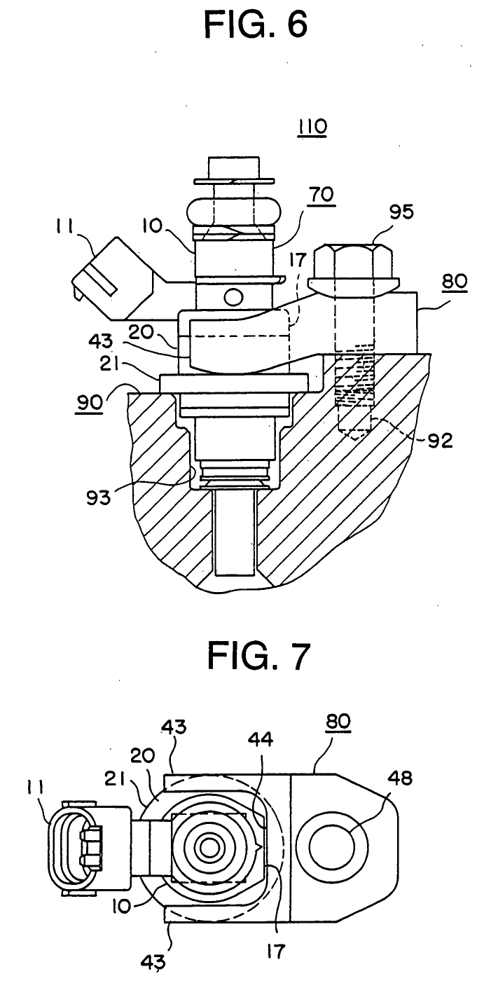

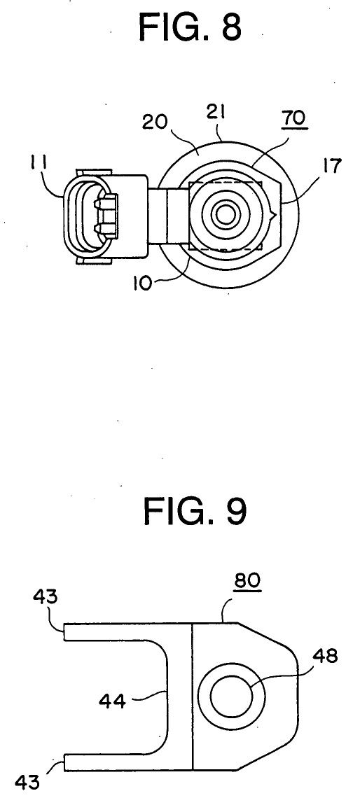

FIG. 6 is a side view, partly in section, of a cylinder injecting fuel injection valve device according to Embodiment 1 of the present invention. FIG. 7 is a top view of the cylinder injecting fuel injection valve device of FIG.6. FIG. 8 is a top view of a fuel injection valve, and FIG. 9 is a top view of a retainer.

In a cylinder injecting fuel injection valve device 110 according to this embodiment, a U-shaped portion 43 serving as the constricting portion of a retainer 80 has an engagement flat surface portion 44, which is a surface longitudinally perpendicular to the claw portions, between two opposing claw portions. The U-shaped portion 43 holds the resin housing 10 of a fuel injection valve 70 between its claw portions, and brings the engagement flat surface portion 44 into contact with a resin flat surface portion 17 formed on a side surface of the resin housing 10 to thereby restrict rotation of the fuel injection valve 70 and to set the external plug connector 11 in a predetermined direction. The resin flat surface portion 17 is formed as a flat surface perpendicular to a plane including the central axis of the fuel injection valve 70 and the central axis of the bolt 95. Otherwise, this embodiment is the same as Embodiment 1. In this embodiment also, it is possible to obtain substantially the same effect as that of Embodiment 1.

Embodiment 3

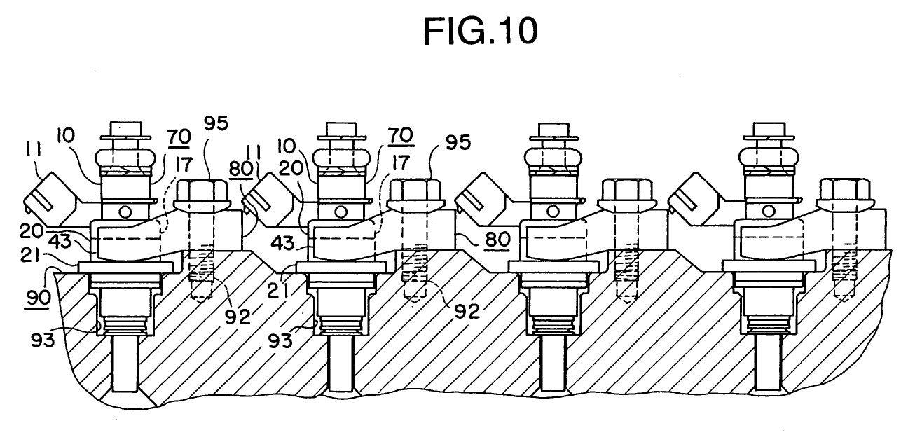

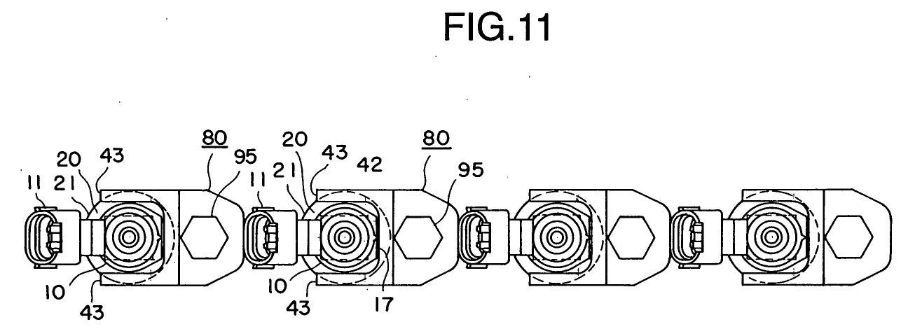

FIG. 10 is a side view, partly in section, of a cylinder injecting fuel injection valve device according to Embodiment 3 of the present invention. FIG. 11 is a top view of the cylinder injecting fuel injection valve device of FIG. 10.

In this embodiment, four fuel injecting fuel injection valve devices according to Embodiment 2 are arranged in a row in conformity with a four-cylinder engine. The respective central axes of the four retainer mounting bolt holes 92 and the respective central axes of the fuel injection valve insertion holes 93 are in the same plane.

In these cylinder injecting fuel injection valve devices, constructed as described above, it is possible to achieve a high level of accuracy in the positional relationship between adjacent fuel injection valves 70 and adjacent retainers 80, so that, as compared with Embodiment 2, it is possible to achieve a still higher level of accuracy in the positioning of the fuel injection valves 70 in the rotating direction. While in this embodiment valve devices according to Embodiment 2 are adopted, it is also possible to obtain the same effect by adopting valve devices according to Embodiment 1, arranging them such that the respective axes of the retainer mounting bolt holes 92 and the respective axes of the fuel injection valve insertion holes 93 of the cylinders of the cylinder head 90 are respectively in the same plane.

According to the present invention, there is provided the cylinder injecting fuel injection valve device to be mounted to the cylinder head of a cylinder injection type internal combustion engine, including: the fuel injection valve arranged with its forward end side portion with the fuel injection port inserted into the fuel injection valve insertion hole formed in the cylinder head, the fuel injection valve including the axially constrained portion formed in the outer periphery of the metal portion formed on the body portion so as to protrude radially outwards and the radially constrained portion of a predetermined configuration formed on the outer peripheral surface of the resin portion provided on the rear end side with respect to the axially constrained portion, the fuel injection valve being adapted to inject fuel directly into the cylinder from the fuel injection port; and the retainer one end of which is fixed to the cylinder head and the other end of which has the constraining portion by means of which the fuel injection valve is secured in position, in which the constraining portion of the retainer abuts the axially constrained portion to axially pressurize the fuel injection valve toward the cylinder head side, and is engaged with the radially constrained portion to thereby restrict rotation of the fuel injection valve around the axis. Therefore, a fuel injection valve mounting method can be attained in which it is possible to easily form a rotational positioning structure for the fuel injection valve without involving any increase in cost and it is possible to effect positioning in the rotating direction with high accuracy.

What is claimed is:

1. A cylinder injecting fuel injection valve device to be mounted to a cylinder head of a cylinder injection type internal combustion engine, comprising:
a fuel injection valve arranged with its forward end side portion with a fuel injection port inserted into a fuel injection valve insertion hole formed in the cylinder head, the fuel injection valve including an axially constrained portion formed in an outer periphery of a metal portion formed on a body portion so as to protrude radially outwards and a radially constrained portion of a predetermined configuration formed on an outer peripheral surface of a resin portion provided on a rear end side with respect to the axially constrained portion, the fuel injection valve being adapted to inject fuel directly into a cylinder from the fuel injection port; and
a retainer one end of which is fixed to the cylinder head and the other end of which has a constraining portion by means of which the fuel injection valve is secured in position,
wherein the constraining portion of the retainer abuts the axially constrained portion to axially pressurize the fuel injection valve toward a cylinder head side, and is engaged with the radially constrained portion to thereby restrict rotation of the fuel injection valve around an axis.

2. A cylinder injecting fuel injection valve device according to claim 1, wherein the axially constrained portion of the fuel injection valve is a flange provided around an entire circumference of an outer peripheral portion of a metal housing accommodating a coil and a valve body.

3. A cylinder injecting fuel injection valve device according to claim 1, wherein the radially constrained portion of the fuel injection valve is a flat surface formed on an outer peripheral surface of a resin housing molded integrally with an external plug connector.

4. A cylinder injecting fuel injection valve device according to claim 1, wherein the retainer is formed of an elastic material, and is fastened to the cylinder head by means of a bolt passed through a through-hole formed in an intermediate portion of the retainer.

5. A cylinder injecting fuel injection valve device according to claim 4, wherein the flat surface formed on the outer peripheral surface of the resin housing of the fuel injection valve comprises two surfaces parallel to a plane including a central axis of the fuel injection valve and a central axis of the bolt.

6. A cylinder injecting fuel injection valve device according to claim 4, wherein the flat surface formed on the outer peripheral surface of the resin housing of the fuel injection valve comprises a flat surface perpendicular to a plane including a central axis of the fuel injection valve and a central axis of the bolt.

7. A cylinder injecting fuel injection valve device according to claim 4, wherein a plurality of the fuel injection valves are mounted to the cylinder head, with a central axis of each fuel injection valve and a central axis of each bolt being in the same plane.
